(19) United States
(12) Patent Application Publication
(10) Pub. No.: US 2026/0141350 A1
(43) Pub. Date: May 21, 2026

(54) SYSTEM AND METHOD FOR SYNCHRONOUS AGGREGATION AND AMALGAMATION OF OCCUPATIONAL SPECIFICATIONS BY INTELLIGENT NEURAL NETWORKING

(71) Applicant: Darrell Thompson, II, Brooklyn, NY (US)

(72) Inventor: Darrell Thompson, II, Brooklyn, NY (US)

(21) Appl. No.: 19/290,898

(22) Filed: Aug. 5, 2025

Related U.S. Application Data
(60) Provisional application No. 63/723,182, filed on Nov. 21, 2024.

(51) Int. Cl. G06Q 10/1053

(52) U.S. Cl. CPC G06Q 10/1053

(57) ABSTRACT

The invention discloses systems and methods for synchronous aggregation and amalgamation of occupational specifications by intelligent neural gathering of US Department of Labor Standard Occupational Classification, and Occupational Information Network standardized data descriptions. The system constructs standardized data configurations of job canon via program-global area data files and cumulative career historical data using system-global area data files, with the purpose of producing the resultant consensus of job canon syntax composition to frameworks using a bi-directional recurrent neural network modeling via template-based data extraction of career historical data by specific recruitment prerequisites, in order to perform consensus matching discernment of candidate to role. The invention is constructed using Logical Data File Descriptions as the modeling source for the compiling, testing and deployment of machine code schema.

### CROSS-REFERENCE TO RELATED APPLICATIONS

This application claims benefit to Provisional Application No. 63/723,182, filed Nov. 21, 2024, the contents of which are herein incorporated by reference.

### BACKGROUND OF THE INVENTION

### Field of Endeavor

The present invention relates to document generation systems and methods, and more particularly, to a system and method for generating occupational specifications utilizing neural networks.

### Background of Related Art

For decades, the prevailing commonality exists, that Human Resources (HR) personnel often re-write job postings and requests for new hires to search for ‘the best fit’ for a role, such that to align with the organization's culture, As a result, despite how qualified candidates are, a vast majority are passed over during the initial vetting processes conducted by HR, due to in no small part by adhering to the company's ‘culture’ (i.e.; the way an organization's people interact with each other, the values they hold, and the decisions they make) in retaining probable interviewees.

Albeit the initial request for new hires and posting new job requests are made exclusively by Hiring Managers to fill a needed role, which by design comprises the comprehensive scope of responsibility and liability that a Hiring Manager retains, it is more likely than not that, the Hiring Manager is the sole person who is responsible and liable in making the decision regarding ‘fit’; hence, the term ‘fit’ is vague and very much subject to definition by the ultimate hiring authority, the Hiring Manager.

Furthermore, it is more likely than not that, a candidate which has been narrowed down to a Hiring Manager's ‘short list’, has demonstrated that the candidate is, by now, ‘the best-fit’ from the perspective of the Hiring Manager, and whomever gets picked, pending background evaluations, etc., are equally likely to be easily hirable.

A problem with HR applying best fit stratagems and standards for a role to align with the organization's culture, by act of causation, regularly promotes concern as it pertains to objective and equitable employment opportunities. As such, the outcome of HR's revisions in their best-fit searches has led to jobs being posted for lengthy periods, including, but not limited to, illegally citing ‘cost-value’ of retaining certain applicants (i.e. 42 U.S.C. Sections 6101-6107) as the cause for the position still remining unfilled, despite interviewing dozens of applicants.

Beginning in the 1990's, HR departments, recruiters and employment services organizations deployed Applicant Tracking Systems, or ATS, to automate the recruitment process, whereas, an ATS-based job posting can be deployed on not just the primary Employer's website, but—with the rapid evolution of e-commerce—literally dozens of independent recruiting websites. As a result, a singular job posting may generate hundreds—or thousands—of applicants.

A still further problem exists, as bias in hiring practices by recruiters have also arisen by these mentioned actions, most notably, through the use of distinctive tactics and stratagems utilized by independent recruiters that host the sanctioned—or, unsanctioned—job sites, requesting an applicant to revise their existing resume to their (i.e. the Recruiter's) revised job posting in order to satisfy the Client/Employer specifications. Either or individually, these have led to hardships, both, financially and utilized time, for the prospective job-seeker, due to a job-seeker's involuntary—and in most cases than less, mandatory—compliance to create ‘multiple versions’ of their resume.

The amassing problem which corroborates with that approach, is the fact that Commercial-Off-the-Shelf (COTS)-based resume parsing software can read 50 to 100 resumes per CPU per second. Widely used within HR and Recruiting environments to supplement the workload of an ATS-batch search, the principal standard exists as a prevailing commonality, whereby it is this action which, equally controls the actual number of resumes that are, in fact, generally read by an actual person, hence commercially documented within the job-hunting/recruiting sphere as the “6-second-rule”.

A further problem exists, as it applies to an external search of applicants, whereas, if an applicant were to file an application thru said independent recruiter or employment service, where said recruiters further apply re-editing and replicating the job post onto their own hosted website, this results in charging an employer a ‘finders-fee” of 20% of an applicant's salary, if (1) said applicant is hired by their services, based solely upon (2) the best-fit incentive of the Client/Employer.

A much further problem with this approach is what is not generally known, yet, fundamentally evident; the methodology of discernment within an ATS. An ATS does not deliberate on how your resume is written (i.e.; format), how it is structured (i.e.; elements/fields) nor, the information it delivers (i.e.; context).

An ATS basically reads-what-it-sees (aka optical character recognition, or OCR), processes the ‘words’ via simple ASCII (American Standard Code for Information Interchange) flat text, and produces the results based upon the search parameters of those performing the search (i.e.; HR Recruiters and independent Recruiters).

Causation effectively tiers a further problem with that approach; whereas, by job-seekers having been falsely encouraged to tailor a resume for each specific job description and application filed via an ATS (i.e.; the ‘multiple versions of a resume’), led to an ensuing business model for creating a market for ‘professionally written, industry-specific optimized-ATS resumes’, thru the counterfactual claim of making resumes ‘simpler for the ATS to read’ by adding marketing context (aka ‘buzzwords’).

The perpetual growth of this market, to recreate a standard resume into an ‘optimized ATS resume’, has cost prospective job-seekers hundreds, if not, thousands of dollars for this product over the last thirty (30) years, yet, a much further problem with that approach is fundamentally evident, as well as not generally known.

If, indeed, a resume is only viewed for six (6) seconds by an actual person, it is most likely than not, that this action by design, precipitously lowers the chances of the resume being considered, irrespective of its context optimization, professionally or otherwise. Thus, the aforementioned problems—propagated by means of tiered causation—is the outcome of decades of ATS-based recruiting.

### SUMMARY OF THE INVENTION

It is a first object of the present invention is to disclose a novel means to aid job seekers to create and submit a straightforward document, which contains the applicable, comprehensive, precise, and up-to-date information of their qualifications as well as conduct a focused, comprehensive search for all available employment opportunities as per their standardized career criterion; in essence, the job seeker's “framework”.

A second further object of the invention is to disclose a novel and useful system in which a user, such as a Hiring Manager, can equally, conduct a candidate search along with posting job requests, as per the explicit requirements of the essential work to be performed, all according to the perspective of the Hiring Manager, as they are the definitive hiring authority.

A conclusive third object of the invention is to irrefutably divulge the context of the prepared document to be applicably efficient to the details of the role as advertised by the Hiring Manager, said document composed of the job-seeker's applicable, comprehensive, precise, and up-to-date information (i.e.; the ‘framework’) of their qualifications as it pertains to said advertised role, exclusively.

The most efficient process to accomplish said objects, is by means of data-template extraction, where the accrued metadata of sources (i.e.; the job-seekers framework, composed of USDOL-standardized career criterion, and the USDOL standardized descriptions of roles) are catalogued, warehoused, authenticated and correlated to perform comprehensive consensus analysis. To perform such analysis without bias or misinterpretation by either, job-seeker or Hiring Manager, analysis can only be accomplished by means of performing consensus processing by means of algorithmic-based machine-learning procedures, commonly referred to as artificial intelligence (AI).

By means of AI-based data template extraction, (1) the prerequisite for posting optimized resumes on various job boards is effectively rescinded, thus (2) affirming the quality of the hire upon comprehensive consensus by means of the job-seeker's criterion as it pertains to the role, as per the Hiring Manager's requirements comprised by the standardized definition of the role, therefore (3) rendering discernment by means of unconscious bias—either by individual, or an individual's decision-effectively suppressed.

The consensus of USDOL standardized context by means of AI-based data template extraction, is the foundation for matching the role to the job seeker, and the search for said job seeker to the needs of the Hiring Manager, thus empowering a job seeker to confidently apply to a Hiring Manager's job post, as both are derived by means of irrefutable standardized alignment of role to candidate's ‘framework’. The invention claimed here solves this problem.

This invention relates to a computer-implemented method, constructed through the use of Logical Data File Descriptions (LDFDs) as the modeling source for the compiling, testing and deployment of machine code schema, for the purpose of algorithm construction required for interrelated system functions as it relates to the sequential iteration of information, for the purpose of statistical data management by means of consensus processing applied through the use of machine-learning technology, commonly referred to as artificial intelligence, or AI, as it alludes to producing subsequent analytics of employment searches and recruitment operations.

AI template-based data extraction is a procedure which comprises data patterns by means of data templates to extract specific data fields and their associated key-value pairs. Applied as the foundation of the inventions'purpose, by means and use of standardized data to construct and frame all relevant context to apply for said job requests with applicable, comprehensive, precise, and up-to-date information, as well as for the purpose of coherence by means of reliability for prospective job-seekers in their employment searching, the current invention provides novel and useful improvements, methods, and processes on what currently exists.

The invention discloses a computer-implemented method, constructed through the use of Logical Data File Descriptions (LDFDs) as the modeling source in rendering the system's successive changes, subsequent phases and progressive events, into the most efficient machine code applicable, for the purpose of gathering and assembling US Department of Labor (USDOL) Standard Occupational Classification (SOC), and the Occupational Information Network (O'NET) standardized data descriptions by means of AI template-based data extraction, for the purpose of compiling a job-seekers ‘framework’ (i.e.; cumulative and explicit career history) via system-global area (SGA) data files, to the consensus syntax composition of job canon by specific recruitment prerequisites (i.e.; trade, specialization, etc.) via program-global area (PGA) data files by means of AI template-based data extraction of USDOL SOC/O'NET data descriptions, in order to, and with the purpose of, constructing and framing all relevant context, as it relates to employment searching and candidate recruitment requirements, by means of applicable, comprehensive, precise, and up-to-date information.

Thus, by means of executable datafile instructions incorporated within constructed algorithms interspersed amongst data-tables created through AI template-based data extraction, in order to integrate said data tables by means of extraction of specific data fields and their associated key-value pairs of related datafiles metadata, produces immutable context properties that can be compared cooperatively to the corresponding and equivalent SOC/O'NET metadata applied, to construct and post a job-description, as well as compiling the input of the criterion information which creates the “framework” of the job-seeker, the current invention provides novel and useful improvements, methods, and processes on what currently exists.

As such, in all related instances, by use of Logical Data Flow Diagrams (LDFD's) as a blueprint, the architecture (i.e. ; designing, construction, testing and deployment) of algorithms to build the optimal machine code for the purpose of the creation of the data templates as well as their associated data file structures, whilst retaining and aligning to the purview of the invention, introduces by design, forthcoming data gathering and processing by means of standardization within a reciprocal structure, and data compiling and formatting by means of inclusion and/or exclusion of the data that needs to be extracted (i.e.; consensus) through the use of AI-based processing. This invention is an improvement on what currently exists.

USDOL data is irrefutably represented compliance in hiring standards, covers all professions in private and public job markets, based upon Federal, State and City employment levels, forecasts by occupation, pay, benefits, required skills and demographics and is annually updated. USDOL data is defined within two (2) categories, referred to as SOC and O'NET. The Standard Occupational Classification (SOC) category, organizes 867 detailed occupations, combining 459 general occupations through 98 minor and 23 major groups. whereas the O'NET category correlates the SOC data by means of affiliating current occupations to their job-related data and skills. Succinctly, SOC classifies the role by vocation (i.e.; task), where O'NET defines the role by profession (i.e.; specialty). O'NET replaced the decommissioned Dictionary of Occupational Titles (DOT) in the 1990's, which was published in the 1930's.

A still further object of the present invention, is to discourage the use of re-edited job postings and job descriptions, whereas the commonality exists that these chosen actions have directly impacted job-searching prospects as well as obstruct fair and equal employment opportunities.

By use of AI template-based data extraction to perform consensus upon standardized data sources to compile and produce valid, comprehensive, precise, and accurate information, by means and use of standardized data to construct and frame all relevant context, by means of scalability to create and post job requests, as well as updating career criterion, the invention claimed here solves this problem.

The present invention elements are novel to align the USDOL data to the foundations of the developing and updating of career criterion, as it pertains to the requirements of said occupation description data to their specific background, by means of affirming the individual's qualifications and skillsets in their totality, as opposed to the distinction of the individual (i.e.; first time employment, entry-level as a College Graduate, entry-level as an Executive, all classes of Veterans, disabled job seekers via State/Federal Vocational Rehabilitation services, etc.,).

Furthermore, as it pertains to the individual job-seeker, the present invention elements are novel, whereas the template which contains said information is scalable over time, yet adapting to the individual; whereas jobs held over time, are coded, categorized and compiled into a framework which encompasses all jobs held, under one (1) banner. Such identification compiled within the SOC/O'NET specific sphere to the individual may be, as it pertains to the invention, referred to as the individual's “CAREER DOMAIN VIA SOC/O'NET CONSENSUS” as it pertains to seeking employment.

As it pertains to the workforce-current and forthcoming—as previously mentioned, the USDOL metadata is annually updated, aligning to private and public job markets, based upon Federal, State and City employment levels, forecasts by occupation, pay, benefits, required skills and demographics. Thus, by means of scalability to create and post job requests utilizing standardized and annually updated data, this invention is an improvement on what currently exists.

Succinctly, while roles may adapt over time, the fundamentals of said role, remain consistent over time. Thus, it is said the individual's “CAREER DOMAIN VIA SOC/O'NET CONSENSUS” template data which effectively renders the ongoing perquisite of constructing multiple versions of the same resume, useless and avoidable, as the template data (i.e.; “associated key-value pair”) is not only comprehensibly organized via AI, but also consistently updated by the individual.

The object of the present invention is fundamentally evident; by use of Logical Data File Descriptions (LDFDs) as the modeling source for the compiling, testing and deployment of the invention's machine code schema, in order to attain all algorithms required for the purpose and use of interrelated system functions as it relates to the sequential iteration of information, by means of the acquisition, retrieval and utilization via consensus processing, of data objects gathered via USDOL Specialized Occupational Classification (SOC) and Occupational Information Network (O'NET) code descriptions, for the purpose of creating system-global area (SGA) and program-global area (PGA) flat files, with the purpose of gathering and compiling the SGA and PGA flat files within data templates, so as to perform consensus processing of the flat file's subsequent and resultant metadata by means and use of AI template-based data extraction.

The invention claimed here achieves the aforementioned actions by means of consensus processing applied through the use of machine-learning technology, commonly referred to as artificial intelligence, or AI, as it alludes to producing subsequent analytics of employment searches and recruitment operations by the aforementioned procedures, processes and actions, for the purpose of statistical data standardization management as it pertains to compiling an individual's cumulative career history as it relates to employment searches, as well as compiling resultant consensus as it pertains to composing detailed recruitment prerequisites via job canon.

The invention claimed here resolves the predisposition of bias by way of re-edited job postings and job descriptions, whereas these actions and commonalities have oftentimes directly impacted job-searching prospects as well as obstruct fair and equal employment opportunities.

This invention relates to a computer-implemented method, constructed through the use of Logical Data File Descriptions (LDFDs) as the modeling source for the compiling, testing and deployment of machine code schema, for the purpose of algorithm construction required for interrelated system functions as it relates to the sequential iteration of information, for the purpose of statistical data management by means of consensus processing applied through the use of machine-learning technology, commonly referred to as artificial intelligence, or AI, as it alludes to producing subsequent analytics of employment searches and recruitment operations.

The innovation of the disclosed invention is to facilitate the acquisition, retrieval and utilization via consensus processing of data objects (US Department of Labor (USDOL) Specialized Occupational Classification (SOC) and Occupational Information Network (O'NET) code descriptions) for the purpose of creating system-global area (SGA) and program-global area (PGA) flat files, with the purpose of gathering and compiling the flat files within data templates, so as to perform consensus processing of the flat file's subsequent and resultant metadata by means and use of AI template-based data extraction.

Queries (job-seeker to employer; employer to job-seeker) are conducted via SGA to PGA consensus per data standardization via AI template-based data extraction. The AI data extraction process creates an SGA data file of a job-seekers ‘framework’ (i.e.; cumulative career history applied to employment searches), within a data template. The interconnected PGA files within a parallel data template comprise of resultant consensus as it pertains to detailed recruitment prerequisites via job canon (i.e.; trade, specialization, etc.), for the purpose of constructing standardized job specifications compiled via syntax composition by means of standardized data (i.e., USDOL SOC/O'NET description) with the resultant documentation of the consensus process being made available to all participating parties.

### BRIEF DESCRIPTION OF THE DRAWINGS

FIG. 1 is an exemplary schematic of the workflow of the process to create the data template ‘Career Domain via SOC/O'NET Consensus’, as well as its ensuing steps with Bi-Directional Recurrent Neural Network (BdRNN) processing to enact the data extraction subset data-tables as well as the document processing;

FIG. 2 is an exemplary schematic of the workflow, illustrating the aforementioned BdRNN process applied to conducting a job search, including auxiliary procedures to generate the required data-table files supporting the BdRNN consensus processing;

FIG. 3 is an exemplary schematic of the workflow, illustrating the aforementioned BdRNN consensus process to generate the required data-table files for ‘job post description’ and ‘candidate search via retrieved ‘career criterion data-table file’;

FIG. 4 is an exemplary schematic of the workflow, illustrating the comprehensive BdRNN process of the candidate search, manager's selection and onboarding process by use of the aforementioned data-table files, as well as those required for document processing; and

FIG. 5 is an exemplary schematic diagram of a system of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

The problem domain addressed by the present system lies in the inefficiencies, biases, and inequities commonly found in conventional recruitment and job-seeking processes. Historically, Human Resources (HR) personnel and recruiters have relied on subjective interpretations of role suitability, often influenced by organizational culture and unconscious biases. This has resulted in prolonged job postings, inequitable hiring practices, and significant challenges for job seekers, including the need to create multiple versions of resumes tailored to specific job descriptions. Applicant Tracking Systems (ATS), while automating certain aspects of recruitment, have compounded these issues by relying on basic parsing techniques that overlook nuanced candidate qualifications, instead prioritizing keyword-based filtering. Furthermore, the widespread use of independent recruiters and job boards has introduced additional inefficiencies, such as redundant job postings, re-edited descriptions, and costly “finder's fees” for employers. These practices have collectively diminished the effectiveness of the hiring process, creating obstacles to fair and equitable employment opportunities.

The concept disclosed herein significantly enhances previous approaches by introducing a system and method for synchronous aggregation and amalgamation of occupational specifications using artificial intelligence (AI) and standardized data sources. The disclosed system employs data-template extraction techniques to process and align metadata from the U.S. Department of Labor (USDOL) Standard Occupational Classification (SOC) and Occupational Information Network (O'NET) databases. By utilizing Logical Data File Descriptions (LDFDs) as the modeling source, the system constructs machine code schema to enable consensus processing through Bi-Directional Recurrent Neural Network (BdRNN) modeling. This architecture facilitates the creation of standardized “frameworks” for job seekers, encompassing their cumulative career history, qualifications, and skillsets, while simultaneously generating precise job canon descriptions for hiring managers based on standardized occupational data. The result is a bias-free, scalable, and efficient matching process that aligns candidates to roles based on irrefutable standardized criteria, eliminating the need for tailored resumes and subjective interpretations of “fit.”

Broadly, the solution integrates AI-driven template-based data extraction to compile and process value pairs from SOC/O'NET metadata, ensuring thorough and precise alignment between job seekers and job postings. The system's architecture supports bi-directional consensus matching, enabling hiring managers to post job requests and conduct candidate searches with exceptional accuracy and efficiency. By standardizing the recruitment process and suppressing unconscious bias, the described system empowers job seekers to confidently apply for roles while providing hiring managers with reliable candidate data. This approach not only streamlines the hiring process but also promotes equitable employment opportunities, addressing longstanding limitations in conventional recruitment methodologies.

Broadly, an aspect of the present invention utilizes the USDOL SOC/O'NET data as the prevailing ‘data template’ for the AI data extraction, such that the data codes are annually updated to accurately present the most up-to-date details covering all job markets-public, private, Federal, State, City-to ratify the outlook of employment and hiring by occupation classification, as well as salary, benefits, and required skills.

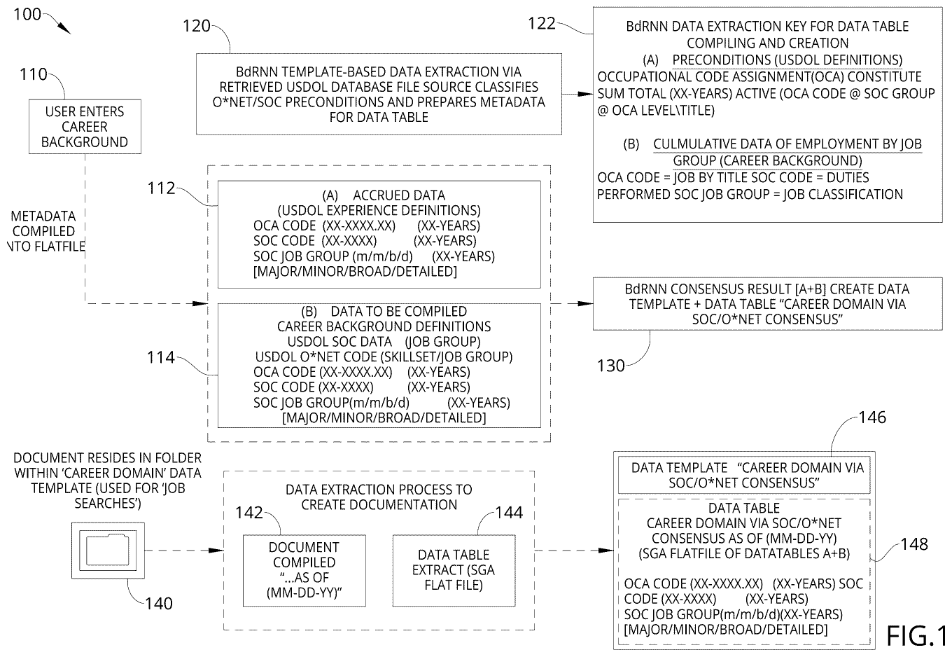

FIG. 1 illustrates a workflow for creating a data template referred to as “Career Domain via SOC/O*NET Consensus” 146. This process integrates user-provided career background information 110 with standardized occupational data from the USDOL databases, utilizing Bi-Directional Recurrent Neural Network (BdRNN) modeling to perform template-based data extraction 120 and consensus processing 130.

At step 110, the user inputs their career background, which includes comprehensive details about their professional history, qualifications, and skillsets. This information serves as the foundational input for the subsequent data processing steps.

At step 112-114, the metadata derived from the user's career background is compiled into a flat file. This flat file organizes the user's input into a structured format, enabling efficient processing and alignment with standardized occupational data.

At step 120, the BdRNN template-based data extraction process retrieves relevant USDOL database file sources, classifies O*NET/SOC preconditions, and prepares the metadata for integration into a data table 148. This step ensures that the user's career background is aligned with standardized occupational classifications and definitions.

At step 122, the BdRNN data extraction mechanism is applied to compile and create the data table 148. This step involves extracting specific data fields and their associated value pairs, ensuring that the compiled data accurately reflects the user's career background and aligns with USDOL SOC/O*NET standards.

At step 130, the BdRNN consensus result combines the extracted data (A+B) to create the data template 146 and data table 148 referred to as “Career Domain via SOC/O*NET Consensus.” This consensus process ensures that the resulting data template is both comprehensive and precise, reflecting the user's career history in alignment with standardized occupational classifications.

At step 140, the document is compiled, including a timestamp indicating the date of creation (e.g., “as of MM-DD-YYYY”). This document serves as a standardized representation of the user's career background, formatted for use in job searches.

At step 144, the data table extract is generated as a system-global area (SGA) flat file. This flat file contains the structured metadata necessary for further processing and integration into the data template 146.

At step 146, the data template “Career Domain via SOC/ONET Consensus” is finalized. This template encapsulates the user's career background, aligned with USDOL SOC/ONET standards, and is ready for use in recruitment and job search processes.

At step 148, the data table is produced, containing the detailed metadata and value pairs derived from the consensus process. This data table plays an important role in the overall workflow, facilitating precise alignment between job seekers and job postings.

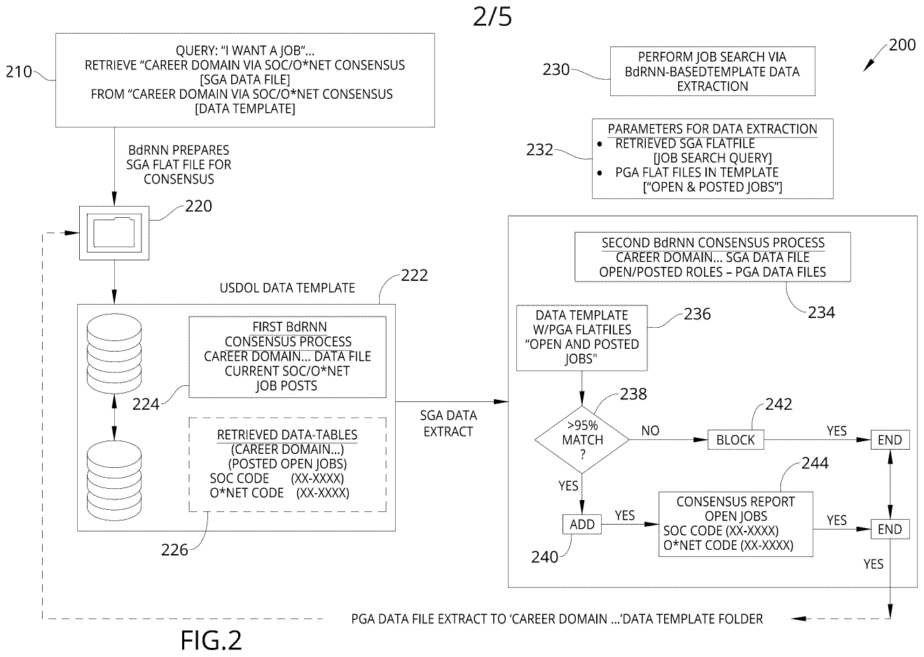

FIG. 2 illustrates a workflow for job search data extraction, utilizing Bi-Directional Recurrent Neural Network (BdRNN) modeling to process and align user-provided career data with standardized occupational data from the U.S. Department of Labor (USDOL) databases. The workflow integrates multiple consensus processes to retrieve, analyze, and match job seeker data with open job postings, ensuring precise alignment based on standardized criteria.

At step 210, the user initiates a query, such as “I want a job,” which triggers the retrieval of the user's “Career Domain via SOC/O*NET Consensus” data file from the corresponding data template 222. This query serves as the foundational input for the subsequent data extraction and matching processes.

At step 220, the BdRNN prepares a system-global area (SGA) flat file for consensus processing. This step organizes the user's career data into a structured format, enabling efficient alignment with USDOL occupational data.

At step 222, the USDOL data template 222 is accessed, providing standardized occupational classifications and definitions necessary for the consensus process. This template serves as the reference point for aligning the user's career data with open job postings.

At step 224, the first BdRNN consensus process is performed, integrating the user's “Career Domain” data file with current SOC/ONET job posts. This process generates retrieved data tables containing detailed metadata, including SOC codes and ONET codes, which facilitate accurate job matching.

At step 226, the retrieved data tables are compiled, encompassing the user's career domain data and the metadata of posted open jobs. These tables include SOC and O*NET codes, which facilitate the subsequent job search and matching processes.

At step 230, the workflow performs a job search using BdRNN-based template data extraction. This step applies the user's query and the retrieved data tables to identify potential matches among open job postings.

At step 232, parameters for data extraction are defined, including the retrieved SGA flat file containing the job search query and program-global area (PGA) flat files in template representing open and posted jobs. These parameters ensure that the data extraction process is both comprehensive and precise.

At step 234, the second BdRNN consensus process is conducted, aligning the user's career domain data file with open and posted roles represented in the PGA data files. This process refines the matching criteria to ensure optimal alignment between the job seeker and available positions.

At step 236, a data template is generated, incorporating PGA flat files for open and posted jobs. This template serves as the basis for evaluating the match quality between the user's career data and job postings.

At step 238, the workflow evaluates whether the match quality surpasses a threshold of 95%. If the match satisfies or surpasses this threshold, the process advances to step 240; otherwise, the workflow transitions to step 242.

At step 240, jobs that meet the match criteria are added to the user's list of potential opportunities. This step ensures that only highly relevant positions are included in the final output.

At step 242, jobs that fail to meet the match criteria are blocked, preventing irrelevant or poorly aligned positions from being considered.

At step 244, a consensus report is generated, summarizing the open jobs that align with the user's career domain data. This report includes SOC and O*NET codes, providing a standardized representation of the matched positions for the user's review.

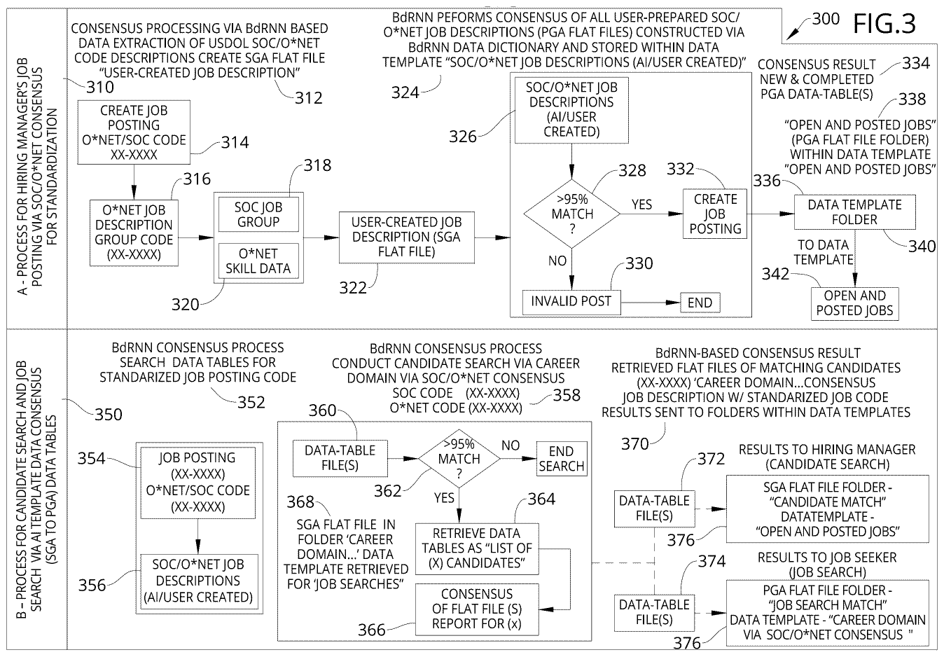

FIG. 3 illustrates a workflow for hiring process consensus 300, utilizing Bi-Directional Recurrent Neural Network (BdRNN) modeling to align user-created job descriptions 322 with standardized occupational data from the U.S. Department of Labor (USDOL) databases. The workflow integrates multiple consensus processes to create job postings, conduct candidate searches, and generate results for hiring managers and job seekers.

310 illustrates a sub-workflow for a hiring manager job posting via SOC/O*NET consensus for standardization, within workflow 300.

At step 312, the workflow begins with consensus processing via BdRNN-based data extraction of USDOL SOC/O*NET code descriptions to create a system-global area (SGA) flat file containing a user-created job description 322. This step ensures that the job description aligns with standardized occupational classifications.

At step 314, the workflow creates a job posting with an O*NET/SOC code, ensuring that the job description is accurately classified according to USDOL standards.

At step 316, the ONET job description group code is generated, providing a detailed classification of the job posting based on ONET standards.

At step 318, the SOC job group is created, further categorizing the job posting according to SOC classifications.

At step 320, the workflow incorporates O*NET skill data into the job description, ensuring that the required skills for the role are accurately represented.

At step 322, the user-created job description is finalized as an SGA flat file, ready for further processing and integration into the consensus workflow.

At step 324, the BdRNN performs consensus processing of all user-prepared SOC/ONET job descriptions stored within program-global area (PGA) flat files. These files are constructed via the BdRNN data dictionary and stored within the data template “SOC/ONET Job Descriptions (AI/User Created)” 326.

At step 326, the SOC/O*NET job descriptions (AI/User Created) are compiled, providing a comprehensive repository of standardized job descriptions for consensus matching.

At step 328, the workflow evaluates whether the match quality surpasses a threshold of 95%. If the match satisfies or surpasses this threshold, the process advances to step 332; otherwise, the workflow transitions to step 330.

At step 330, invalid job postings are identified and excluded from further processing, ensuring that only valid and well-aligned postings are considered.

At step 334, the consensus result generates new and completed PGA data tables, which are stored within the data template “Open and Posted Jobs” 336.

At step 336, the “Open and Posted Jobs” PGA flat file folder is updated within the data template, ensuring that all job postings are accurately categorized and accessible for further processing.

At step 338, the data template folder is finalized, encapsulating all relevant job postings and associated metadata.

At step 340, the workflow transitions the data template to the next stage of processing, ensuring seamless integration into subsequent steps.

At step 342, the “Open and Posted Jobs” data template is prepared for use in candidate searches and hiring processes.

350 illustrates a sub-workflow for a candidate search and job search via AI template based data consensus, within workflow 300.

At step 352, the BdRNN consensus process searches data tables for standardized job posting codes, ensuring precise alignment between job descriptions and candidate data.

At step 354, the job posting is finalized with an O*NET/SOC code, providing a standardized representation of the role for candidate matching.

At step 356, the SOC/O*NET job descriptions (AI/User Created) are utilized to facilitate the candidate search process.

At step 358, the BdRNN consensus process conducts a candidate search via the “Career Domain via SOC/O*NET Consensus,” aligning candidate data with standardized job codes.

At step 360, data-table files are retrieved, containing detailed metadata necessary for evaluating candidate matches.

At step 362, the workflow evaluates whether the match quality surpasses a threshold of 95%. If the match satisfies or surpasses this threshold, the process advances to step 364; otherwise, the workflow transitions to the end of the search.

At step 364, the data-table files are retrieved as list of job candidates. In embodiments, SGA flat files are retrieved for job searches.

At step 366, the consensus of flat files and reports is generated for matched candidates, ensuring that all data is accurately documented.

At step 368, the SGA flat file in the folder “Career Domain...” data template is retrieved for job searches, providing a structured repository of candidate data.

At step 370, data tables are retrieved as a list of matching candidates, ensuring that only highly relevant candidates are included in the final output.

At step 372, the BdRNN-based consensus result retrieves flat files of matching candidates, aligning their career domain data with standardized job descriptions and codes. The results are sent to folders within data templates for further processing.

At step 374, the results of the candidate search are sent to the hiring manager, providing a comprehensive list of potential candidates for review.

At step 376, the results of the job search are sent to the job seeker, empowering them with precise and standardized information about available opportunities.

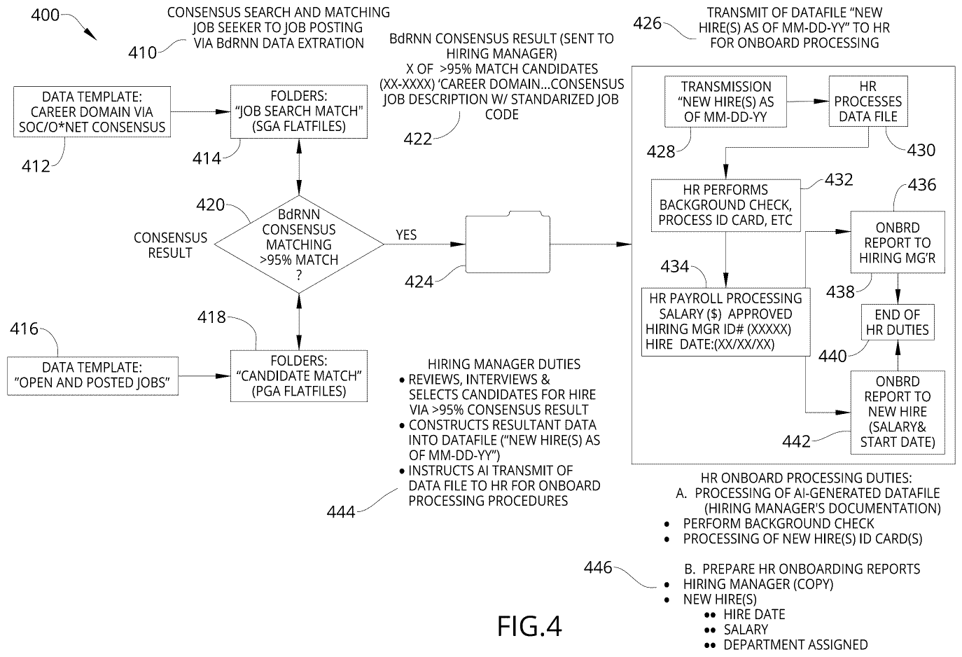

FIG. 4 illustrates a workflow 400 for the hiring process, utilizing Bi-Directional Recurrent Neural Network (BdRNN) modeling to align job seeker data with job postings and facilitate onboarding procedures. The workflow integrates multiple consensus processes to match candidates to roles, transmit hiring data, and complete HR onboarding tasks.

At step 410, the workflow begins with a consensus search and matching process, where BdRNN data extraction aligns job seeker data with job postings. This step utilizes the “Career Domain via SOC/O'NET Consensus” data template 412 and stores the results in folders labeled “Job search match” as system-global area (SGA) flat files 414.

At step 418, the consensus result is evaluated to determine whether the match quality surpasses a threshold of 95%. At step 420, if the match quality exceeds 95%, the workflow proceeds to step 422, where the BdRNN consensus result is sent to the hiring manager. This result includes a list of candidates with a match quality above 95%, along with their “Career Domain” data and standardized job codes.

At step 424, the hiring manager reviews the consensus results and selects candidates for hire.

At step 426, the data file containing the new hires is transmitted to HR. At step 428, HR processes the data file, initiating onboarding tasks. At step 432, HR performs background checks, processes identification cards, and completes other administrative tasks necessary for onboarding.

At step 434, HR processes payroll information, including salary details, hiring manager identification numbers, and hire dates. At step 436, an onboard report is sent to the hiring manager, summarizing the completed HR duties.

At step 438, the Human Resources department concludes onboarding responsibilities, and at step 440, an onboard report is sent to the new hire. This report includes details such as salary and start date, ensuring the new hire is informed of employment terms.

Throughout the workflow, the “Open and posted jobs” data template 416 and folders labeled “Candidate match” as program-global area (PGA) flat files 444 are utilized to facilitate the matching and hiring processes. The integration of BdRNN consensus modeling ensures precise alignment between job seekers and job postings, streamlining the hiring process and promoting equitable employment opportunities.

At step 446, the hiring manager constructs a resultant data file labeled “new hires” with a timestamp indicating the date of creation (e.g., “as of MM-DD-YY”) and transmits this file to HR for onboarding processing procedures.

FIG. 4 illustrates a workflow for the hiring process, utilizing Bi-Directional Recurrent Neural Network (BdRNN) modeling to align job seeker data with job postings and facilitate onboarding procedures. The workflow integrates multiple consensus processes to match candidates to roles, transmit hiring data, and complete HR onboarding tasks.

At step 410, the workflow begins with a consensus search and matching process, where BdRNN data extraction aligns job seeker data with job postings. This step utilizes the “Career Domain via SOC/O'NET Consensus” data template 412 and stores the results in folders labeled “Job search match” as system-global area (SGA) flat files 414.

At step 418, the consensus result is evaluated to determine whether the match quality surpasses a threshold of 95%. At step 420, if the match quality exceeds 95%, the workflow proceeds to step 422, where the BdRNN consensus result is sent to the hiring manager. This result includes a list of candidates with a match quality above 95%, along with their “Career Domain” data and standardized job codes.

At step 424, the hiring manager reviews the consensus results and selects candidates for hire. At step 446, the hiring manager constructs a resultant data file labeled “new hires” with a timestamp indicating the date of creation (e.g., “as of MM-DD-YY”) and transmits this file to HR for onboarding processing procedures.

At step 426, the data file containing the new hires is transmitted to HR. At step 428, HR processes the data file, initiating onboarding tasks. At step 432, HR performs background checks, processes identification cards, and completes other administrative tasks necessary for onboarding.

At step 434, HR processes payroll information, including salary details, hiring manager identification numbers, and hire dates. At step 436, an onboard report is sent to the hiring manager, summarizing the completed HR duties.

At step 438, the Human Resources department concludes onboarding responsibilities, and at step 440, an onboard report is sent to the new hire. This report includes details such as salary and start date, ensuring the new hire is informed of employment terms.

At step 446, the hiring manager constructs a resultant data file labeled “new hires” with a timestamp indicating the date of creation (e.g., “as of MM-DD-YY”) and transmits this file to HR for onboarding processing procedures.

Throughout the workflow, the “Open and posted jobs” data template 416 and folders labeled “Candidate match” as program-global area (PGA) flat files 444 are utilized to facilitate the matching and hiring processes. The integration of BdRNN consensus modeling ensures precise alignment between job seekers and job postings, streamlining the hiring process and promoting equitable employment opportunities.

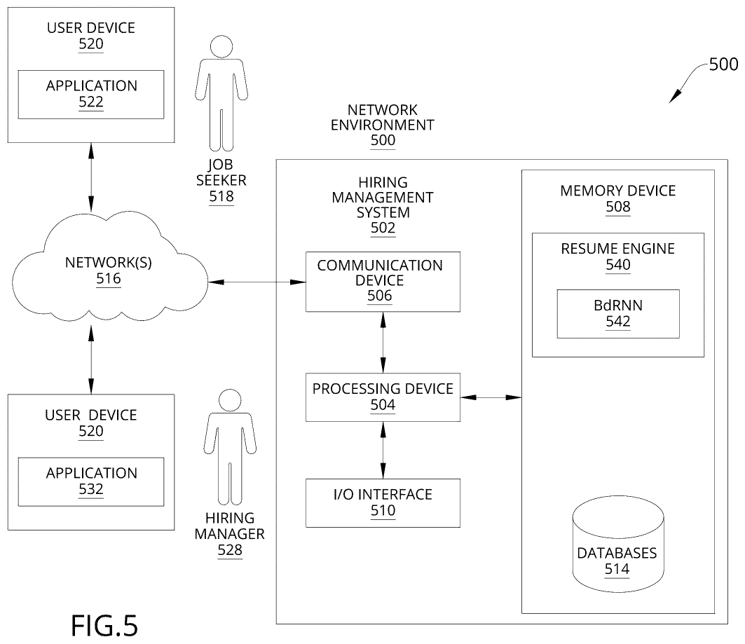

FIG. 5 illustrates a system diagram of a hiring management system 500. The hiring management system 500 operates within a network environment 500 and comprises a processing device 504, a communication device 506, a memory device 508, an I/O interface 510, databases 514, a resume engine 540, and a Bi-Directional Recurrent Neural Network (BdRNN) 542. The system interacts with external components, including network(s) 516, job seekers 518, hiring managers 528, user devices 520, and applications 522.

The processing device 504 is responsible for executing instructions and managing the operations of the hiring management system 500. The processing device 504 coordinates the interaction between the communication device 506, memory device 508, and I/O interface 510 to ensure seamless functionality. Additionally, the processing device 504 facilitates the execution of algorithms and data processing tasks required for the hiring management system 500.

The communication device 506 enables the hiring management system 500 to interact with external components, such as network(s) 516, user devices 520, and applications 522. This device supports data transmission and reception, ensuring that job seekers 518 and hiring managers 528 can access and utilize the functionalities of the system in an efficient manner.

The memory device 508 stores significant components of the hiring management system 500, including the resume engine 540 and the BdRNN 542. The resume engine 540 processes and analyzes job seeker data, generating standardized career frameworks aligned with USDOL SOC/O*NET standards. The BdRNN 542 performs consensus processing, enabling precise alignment between job seeker data and job postings.

The I/O interface 510 facilitates interaction between the hiring management system 500 and external devices or systems. This interface supports input and output operations, enabling data exchange between the system and users, such as job seekers 518 and hiring managers 528.

The databases 514 store structured data necessary for the hiring management system 500, including job descriptions, candidate profiles, and metadata derived from USDOL SOC/O*NET standards. These databases 514 ensure that the system has access to accurate and up-to-date information for processing and matching tasks.

The network(s) 516 provide the connectivity required for the hiring management system 500 to interact with job seekers 518, hiring managers 528, user devices 520, and applications 522. The network(s) 516 enable real-time communication and data exchange, ensuring efficient operation of the system.

The job seeker 518 interacts with the hiring management system 500 through a user device 520 and an application 522. The application 522 allows the job seeker 518 to input their career background, initiate job searches, and review matched opportunities generated by the system.

The hiring manager 528 also interacts with the hiring management system 500 through a user device 520 and an application 522. The application 522 enables the hiring manager 528 to create job postings, conduct candidate searches, and review matched candidates provided by the system.

The resume engine 540 and BdRNN 542 within the memory device 508 work collaboratively to process and align data. The resume engine 540 generates standardized career frameworks for job seekers 518, while the BdRNN 542 performs consensus processing to match these frameworks with job postings created by hiring managers 528. This ensures precise and equitable alignment between candidates and roles.

The processing device 504, the communication device 506, the memory device 508, and the I/O interface 510 can be interconnected via a system bus. The system bus can be and/or include a control bus, a data bus, an address bus, and the like. The processing device 504 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and the like. As used herein, “processor,” “processing component,” “processing device,” and/or “processing unit” can be used generically to refer to any or all of the aforementioned specific devices, elements, and/or features of the processing device. While FIG. 5 illustrates a single processing device 504, the hiring management system 502 can include multiple processing devices 504, whether the same type or different types.

The memory device 508 can be and/or include one or more computerized storage media capable of storing electronic data temporarily, semi-permanently, or permanently. The memory device 508 can be or include a computer processing unit register, a cache memory, a magnetic disk, an optical disk, a solid-state drive, and the like. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device 508. While FIG. 5 illustrates a single memory device 508, the hiring management system 502 can include multiple memory devices 508, whether the same type or different types.

The communication device 506 enables the hiring management system 502 to communicate with other devices and systems. The communication device 506 can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a WiFi Direct™ Wi-Fi tm connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. programming installed on a processor, such as the processing component, coupled to the antenna.

An indirect link can include a link between two or more devices where data can pass through an intermediary, such as a router, before being received by an intended recipient of the data. For example, the indirect link can include a Wi-Fi connection where data is passed through a Wi-Fi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long-term evolution (“LTE”) standard, and so forth.

The hiring management system 502 can communicate with one or more network resources 540 via the network 516. The one or more network resources 540 can include external databases, social media platforms, search engines, file servers, web servers, or any type of computerized resource that can communicate with the hiring management system 502 via the network 516.

In embodiments, the components and functionality of the hiring management system 102 can be hosted and/or instantiated on a “cloud” and/or “cloud service.” As used herein, a “cloud” and/or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the hiring management system 508 can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “content” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in the network environment 500 can include a user interface for outputting information in a format perceptible by a user and receiving input from the user. The user interface can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The user interface can include an acoustic element such as a speaker, a microphone, and so forth. The user interface can include a button, a switch, a keyboard, a touch-sensitive surface, a touchscreen, a camera, a fingerprint scanner, and so forth. The touchscreen can include a resistive touchscreen, a capacitive touchscreen, and so forth.

The hiring management system 500, as illustrated in FIG. 5, provides a comprehensive and efficient solution for recruitment and job searching, leveraging advanced AI-driven processes to promote equitable employment opportunities and streamline hiring operations.

It should be understood, of course, that the foregoing relates to exemplary embodiments of the invention and that modifications may be made without departing from the spirit and scope of the invention as set forth in the following claims.

What is claimed is:

1. A hiring management system, comprising:
a processing device;
a memory device in communication with the processing device, the memory device storing instructions that, when executed by the processing device, cause the processing device to:
receive career background information from a job seeker via a communications interface;
retrieve standardized occupational classification data from an external database;
apply a Bi-Directional Recurrent Neural Network (BdRNN)-based template data extraction process constructed using Logical Data File Descriptions as a modeling source to:
extract specific data fields and associated data-value pairs from the career background information to generate a system-global area (SGA) data file; and
extract specific data fields and associated data-value pairs from the standardized occupational classification data to generate a program-global area (PGA) data file;
perform consensus processing on the SGA data file and the PGA data file to generate:
a job seeker data template representing a career framework; and
a job posting data template representing job postings classified according to the standardized occupational classification data;
evaluate a match quality between the job seeker data template and the job posting data template; and
in response to the match quality meeting or exceeding a predetermined threshold, generate lists of matched job opportunities for the job seeker and matched candidate frameworks for a hiring manager; and
a communication device in communication with the processing device, configured to transmit the lists of matched job opportunities to the job seeker and the matched candidate frameworks to the hiring manager, wherein the consensus processing comprises comparing immutable context properties derived from the value pairs in the SGA data file and the PGA data file.

2. The system of claim 1, wherein the standardized occupational classification data comprises:
Standard Occupational Classification (SOC) data; and
Occupational Information Network (O*NET) data retrieved from a U.S. Department of Labor database.

3. The system of claim 1, wherein the predetermined threshold comprises a match quality of at least 95%.

4. The system of claim 1, wherein the memory device further stores instructions that, when executed by the processing device, cause the processing device to:
store the system-global area data file; and
store the program-global area data file in a database.

5. The system of claim 1, wherein the memory device further stores instructions that, when executed by the processing device, cause the processing device to:
timestamp each generated job seeker data template with a first date of creation; and
timestamp each job posting data template with a second date of creation.

6. A computer-implemented method, comprising:
receiving career background information from a job seeker;
retrieving standardized occupational classification data from an external database;
applying a Bi-Directional Recurrent Neural Network-based template data extraction process constructed using Logical Data File Descriptions as a modeling source to:
extract first specific data fields and associated data value pairs from the career background information to generate a system global area data file; and
extract second specific data fields and associated data value pairs from the standardized occupational classification data to generate a program global area data file;
performing consensus processing on the system global area data file and the program global area data file to generate a job seeker data template representing a career framework for the job seeker and a job posting data template representing job postings classified according to the standardized occupational classification data, wherein the consensus processing comprises comparing immutable context properties derived from the associated data value pairs in the system global area data file and the program global area data file;
evaluating a match quality between the job seeker data template and the job posting data template;
in response to the match quality meeting or exceeding a predetermined threshold, generating a list of matched job opportunities for the job seeker and a list of matched candidate frameworks for a hiring manager; and
transmitting the list of matched job opportunities to the job seeker and transmitting the list of matched candidate frameworks to the hiring manager.

7. The method of claim 6, wherein the standardized occupational classification data comprises Standard Occupational Classification data and Occupational Information Network data.

8. The method of claim 6, further comprising:
storing the system global area data file; and
storing the program global area data file in a database.

9. The method of claim 6, wherein the predetermined threshold comprises a match quality of at least 95%.

10. The method of claim 6, further comprising:
timestamping each generated job seeker data template; and
timestamping each generated job posting data template with a date of creation.

11. A non-transitory computer-readable medium storing instructions that, when executed by one or more processors, cause the one or more processors to:
receive career background information from a job seeker;
retrieve standardized occupational classification data from an external database;
apply a Bi-Directional Recurrent Neural Network-based template data extraction process constructed using Logical Data File Descriptions as a modeling source to:
extract first specific data fields and associated data-value pairs from the career background information to generate a system-global area data file; and
extract second specific data fields and associated data-value pairs from the standardized occupational classification data to generate a program-global area data file;
perform consensus processing on the system-global area data file and the program-global area data file to generate:
a job seeker data template representing a career framework for the job seeker; and
a job posting data template representing job postings classified according to the standardized occupational classification data, wherein the consensus processing comprises comparing immutable context properties derived from the associated data-value pairs in the system-global area data file and the program-global area data file;
evaluate a match quality between the job seeker data template and the job posting data template;
in response to the match quality meeting or exceeding a predetermined threshold, generate:
a list of matched job opportunities for the job seeker; and
a list of matched candidate frameworks for a hiring manager; and
transmit the list of matched job opportunities to the job seeker and the list of matched candidate frameworks to the hiring manager.

12. The non-transitory computer-readable medium of claim 11, wherein the standardized occupational classification data comprises Standard Occupational Classification data and Occupational Information Network data.

13. The non-transitory computer-readable medium of claim 11, wherein the predetermined threshold comprises a match quality of at least 95%.

14. The non-transitory computer-readable medium of claim 11, wherein the instructions further cause the one or more processors to:
store the system-global area data file; and
store the program-global area data file in a database.

15. The non-transitory computer-readable medium of claim 11, wherein the instructions further cause the one or more processors to timestamp:
each generated job seeker data template; and
each generated job posting data template with a date of creation.

16. The non-transitory computer-readable medium of claim 11, wherein the instructions further cause the one or more processors to filter from the list of matched job opportunities any job postings having a match quality below the predetermined threshold.

17. The non-transitory computer-readable medium of claim 11, wherein the instructions further cause the one or more processors to generate a consensus report comprising standardized occupational classification codes for the list of matched job opportunities.

18. The non-transitory computer-readable medium of claim 11, wherein the Bi-Directional Recurrent Neural Network-based template data extraction process comprises a Bi-Directional Long Short-Term Memory network.

19. The non-transitory computer-readable medium of claim 11, wherein the instructions further cause the one or more processors to present the list of matched job opportunities to the job seeker via a graphical user interface.

20. The non-transitory computer-readable medium of claim 11, wherein the instructions further cause the one or more processors to present the list of matched candidate frameworks to the hiring manager via a graphical user interface.
